(19) United States
(12) Patent Application Publication
(10) Pub. No.: US 2008/0312985 A1
(43) Pub. Date: Dec. 18, 2008

(54) COMPUTERIZED EVALUATION OF USER IMPRESSIONS OF PRODUCT ARTIFACTS

(75) Inventors: Don Williams, Woodville, WA (US); Craig Bartholomew, Seattle, WA (US); Terry Sullivan, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/764,369

(22) Filed: Jun. 18, 2007

(51) Int. Cl. G06Q 99/00

(52) U.S. Cl. 705/7

(57) ABSTRACT

Computerized systems and methods for use in evaluating user impressions of a product are provided. One method disclosed includes receiving from a developer of a product, a canonical textual description of an intended product audience and an intended use of a product. The product is displayed to potential users, and from each of a plurality of potential users, a user textual description of the product is received. The user textual description indicates a user impression of the intended product audience and the intended use of the product. A computing device may be used to perform semantic analysis to determine correspondence between the canonical and user textual descriptions, and to display the result in a graph or textual form, for example.

### BACKGROUND

The marketplace is full of competing computer software products, which are growing in complexity. As technology progresses, new categories of software products emerge with new and powerful feature sets. Faced with so many choices, it can be difficult for consumers to ascertain, for example, at the point of purchase, the extent to which a particular software product is intended for a specific user or task. This difficulty may result in lost sales, or a high rate of returned software products due to consumers purchasing products that are not appropriate for their needs. As a result, computer software developers face the challenge of effectively determining the extent to which a software product successfully communicates its intended purpose and target audience to consumers. Stakeholder intuition and expert opinions are insufficient bases for answering these questions, especially as regards new features not present in prior products.

### SUMMARY

Computerized systems and methods for use in evaluating user impressions of a product are provided. One method disclosed includes receiving from a developer of a product, a canonical textual description of an intended product audience and an intended use of a product. The product is displayed to potential users, who are asked to provide a user textual description of the product. The user textual description indicates a user impression of the intended product audience and the intended use of the product. A computing device may be used to perform semantic analysis to determine correspondence between the canonical textual description and the user textual descriptions, and to display the result in a graph or textual form, for example. The result of the semantic analysis can be provided to developers in a feedback loop, to further inform the design and development process. In some applications, these systems and methods may enable developers to iteratively hone their designs to better communicate to users an intended target audience and use, and may also help developers and other stakeholders identify key features that help drive adoption of a particular software product or service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an embodiment of a system for evaluating user impressions of a product.

FIGS. 2A and 2B illustrate screens of a trial graphical user interface of the system of FIG. 1.

FIG. 3 is a depiction of a product artifact report interface of an analysis graphical user interface of the system of FIG. 1.

FIG. 4 is a depiction of a screen of a product comparison interface of the analysis graphical user interface of the system of FIG. 1.

FIG. 5A is a flowchart of an embodiment of a method for use in evaluating user impressions of a product.

FIG. 5B is a continuation of the flowchart of FIG. 5A.

### DETAILED DESCRIPTION

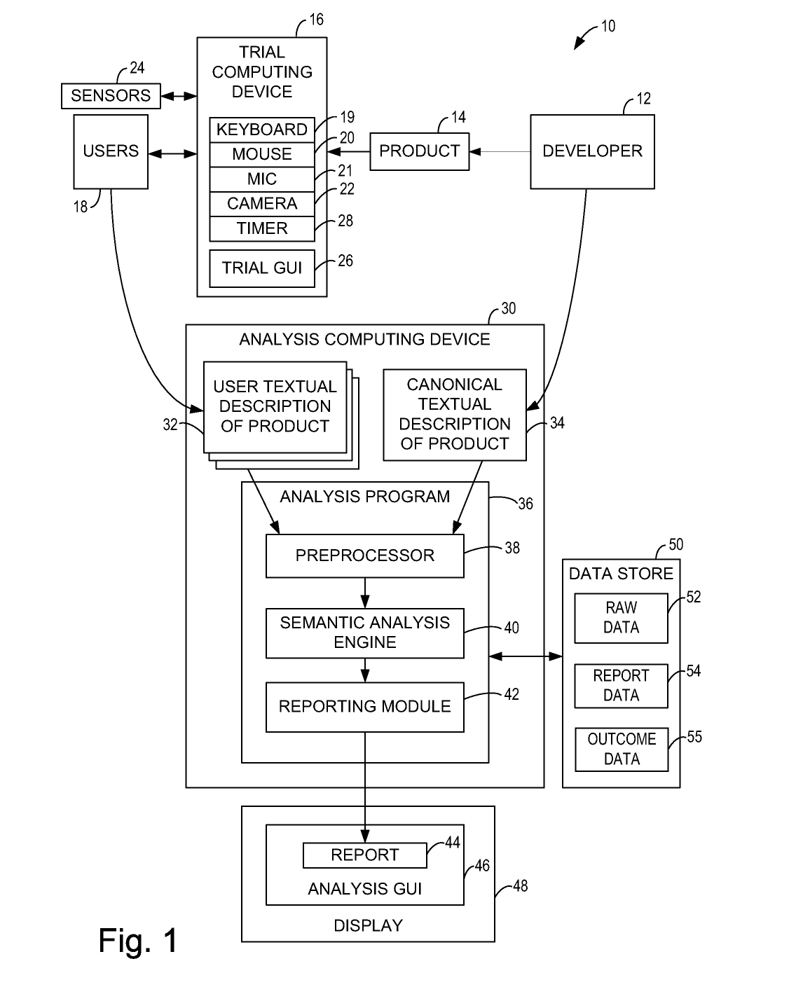

FIG. 1 illustrates an embodiment of a system 10 for evaluating user impressions of a product. Within system 10, a developer 12 produces a product 14 for trial and evaluation on a trial computing device 16 by a plurality of potential users 18. The trial computing device 16 is configured to receive user feedback data from each of the plurality of users 18 via a user input devices such as a keyboard 19, mouse 20, microphone 21, and camera 22, and also via sensors 24 configured to detect various user physiological data.

A trial graphical user interface (GUI) 26 is provided by which one or more artifacts of the product 14 are presented to users 18. The term “product artifact” is used herein to refer to a tangible or intangible item that represents or is associated with a product, such as screenshots, images, graphical user interfaces, sounds, drawings, test marketing materials, websites, product prototypes, product concepts, product paper presentations, product descriptions, etc., and the term “product” encompasses one or more of these product artifacts. Sensors 24 are configured to detect a physiological condition of the user, camera 22 is configured to track eye position of the user, microphone 21 is configured to record comments of the user while the product is presented to the user. A timer 28 may be provided to record an elapsed time each user spends observing the product via the trial GUI 26. As described below, the trial GUI 26 may also be configured with a text input mechanism 56 for receiving a user textual description 32 of the product.

It will be appreciated that the term “developer” as used herein refers broadly to those involved in the development of products, including but not limited to designers, marketing managers, product managers, and product planners.

The trial computing device may be a stand alone personal computing device configured to operate offline and/or online, i.e., with and/or without network connectivity to analysis computing device. In addition, the trial computing device may be a web enabled device and trial GUI may be web-based. The trial computing device may also be a point of sale device configured to display the trial GUI to a shopper. In some embodiments, user feedback such as data obtained through sensors 24, camera 22, and microphone 21 may be taken in a naturalistic environment, such as a simulated or actual shopping environment, use environment, etc. Further, it should be appreciated that the user textual description may be handwritten or orally transmitted to a human administrator of a trial, rather than entered through a GUI of a trial computing device. The user textual description may later be entered into an analysis computing device for processing, if desired.

The user textual description 32 from the plurality of users 18 is typically sent via the trial computing device 16 to an analysis computing device 30, for computerized analysis. While the analysis computing device 30 and the trial computing device 16 are illustrated as separate devices, it will be appreciated that the trial computing device and analysis computing device alternatively may be incorporated into a single computing device, or may be distributed among multiple computing devices. For example, a plurality of networked computers may be used as the trial computing device, and the trial GUI may be an online product survey that is downloadable via a browser.

The analysis computing device 30 is configured to receive from the developer 12 of product 14, a canonical textual description 34 of an intended product audience and an intended use of a product, and also to receive from each of a plurality of potential users 18, the user textual description 32 of respective user impressions of the intended product audience and the intended use of the product. The user impressions may include the user's reactions to the product artifact and the user's understanding and assumptions of the appropriate use and implied value to the user or others. Based on these user impressions, a determination of the “desirability” and “perceived utility” of a product artifact may be made.

The analysis computing device 30 may be configured to execute an analysis program 36 having a preprocessor 38, a semantic analysis engine 40, and a reporting module 42. The preprocessor 38 may be configured to convert raw input data for the user textual description and the canonical product description into a processable format for the semantic analysis engine 40. Preprocessing may include: punctuation stripping, casefolding (harmonizing characters to upper or lower case), stoplisting (removal of non-content-bearing grammatical “infrastructure” terms, such as articles or prepositions), lemmatization, and systematic removal of terms that occur in only one or two narratives. Output from the preprocessor is a series of binary term vector representations of the individual narratives. The semantic analysis engine 40 receives the pre-processed data from the preprocessor 38, and is configured to perform semantic analysis to compare the canonical textual description with the plurality of user textual descriptions. The semantic analysis performed by the semantic analysis engine is described below in detail with respect to method 500.

Analysis computing device 30 includes an associated display 48, which may be an integrated or separate component from the analysis computing device 30. The analysis program 36 may be configured to send an output of the semantic analysis engine 40 for display in a report 44 on an analysis GUI 46 associated with the analysis program 36, via the reporting module 42. Further, the analysis program 36 may also be configured to send an output of user feedback data gathered from the keyboard 19, mouse 20, microphone 21 camera 22, sensor 24, and timer 28 or other devices, for display on the graphical user interface of the analysis program, along with the output of the semantic analysis.

The analysis computing device typically includes an associated data store 50 in which both the preprocessed raw data 52, such as preprocessed user textual descriptions 32 and canonical textual descriptions 34, user feedback data from the various sources listed above etc., can be stored. In addition, data store 50 is typically configured to store processed report data 54, including the output of the semantic analysis engine, processed user feedback data, etc. Behavior-based outcome data 55, such as data indicating whether a potential user actually purchased or recommended product 14, may also be gathered and stored in stored data store 50. This outcome data may be sent to analysis program 36 and included within report 44 by reporting module 42.

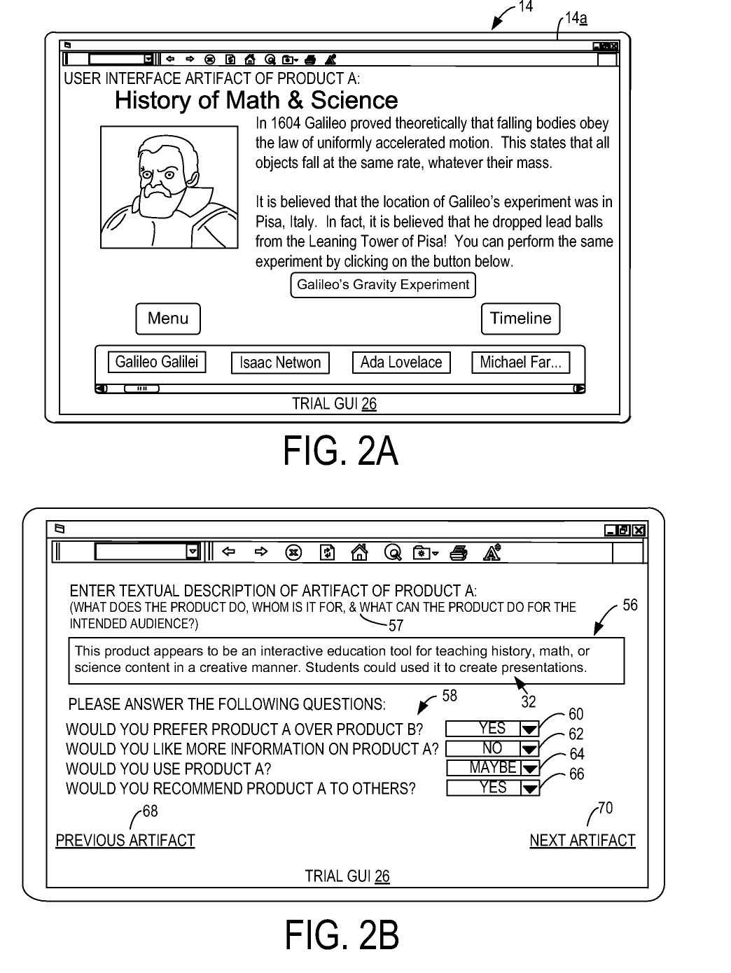

As illustrated in FIGS. 2A and 2B, the trial GUI 26 may be configured to display an artifact 14a of the product 14 to the user 18 in a first screen illustrated in FIG. 2A, and may also be configured with a text input mechanism 56 for receiving a user textual description of the product in a second screen illustrated in FIG. 2B. As explained above, the artifact may be a screen image, a working interface, a sound, a drawing, or virtually any other aspect of the product. In the illustrated embodiment, the product artifact is displayable via trial GUI 26. It will be appreciated that alternatively, the product artifact may be a tangible object directly presented to a user, or intangible object presented to a user other than by trial GUI 26.

The text input mechanism 56 may be configured to display an established protocol 57 for entry of the user textual description 32, including asking what does the product do, whom the product is for, and what does the product do for the intended product audience. Further the protocol may include non-displayable parameters, such as a predefined period of time of exposure of the product to the potential user, a predefined period of time for reflection prior to entry of user input, and a predefined period of time for entering user input, etc. Thus, trial GUI 26 may be configured to follow the predefined protocol and display the artifact 14a of the product 14 to the user for a predetermined period of time, pause for a predetermined period of reflection time, and then display the text input mechanism 56 and other input selectors described herein to the user to allow user input of the user textual description 32 of the product and other user feedback.

The trial GUI 26 may further be configured with a plurality of user input selectors 58 configured to enable the user to input feedback relating to the artifact 14a of the product 14. For example, a product preference selector 60 may be provided by which the user is forced to make a selection between the displayed product and another product. An information selector 62 may be provided by which a user may select to request more information on the product. A use preference selector 64 may be provided by which a user may indicate that the user would use the displayed product 14. And, a recommendation selector 66 may be provided by which the user may indicate that the user would recommend the product to others.

It will be appreciated that a plurality of artifacts 14a for a given product 14 may be presented to the potential users via trial GUI 26. To navigate between these various artifacts, a previous artifact link 68 and next artifact link 70 are provided on the trial GUI 26.

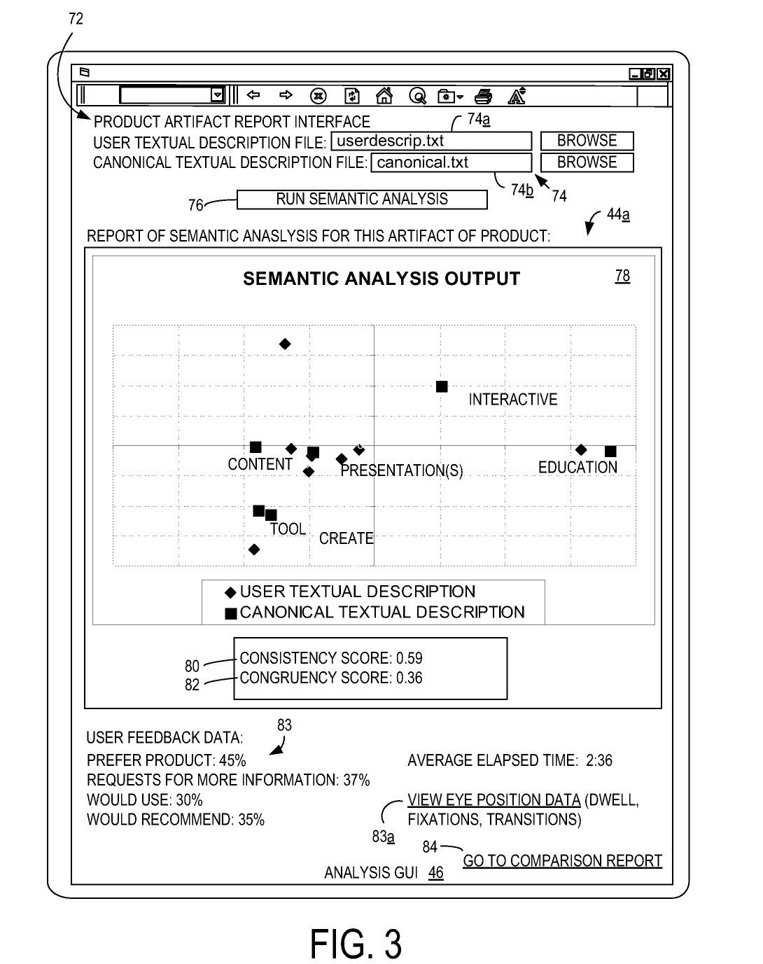

As shown in FIG. 3, the reporting module 42 is configured to generate a product artifact report interface 72 for display on analysis GUI 46. The product artifact report interface 72 may include one or more user selectors 74, such as user textual description file selector 74a and canonical textual description file selector 74b, which are respectively configured to enable a user to select files containing the user textual description 32 and the canonical textual description 34 for the semantic analysis. Once the files are selected, a user may actuate a run selector 76 to perform semantic analysis and display the results of the semantic analysis via a product artifact report 44a on the product artifact report interface.

The semantic analysis engine may be configured to implement one or more of a plurality of semantic analyses that permit systematic representation and analysis of user narrative content, including keyword extraction, correspondence analysis, and discriminant analysis. Specifically, keyword extraction, weighted using, for example, tf*idf (term frequency/inverse document frequency), may allow an analyst to identify specific narrative terms that most uniquely identify specific clusters of user narratives. Correspondence Analysis (CA) is part of a family of dimensionality reduction methods that has been applied successfully to text analysis tasks. Application of a dimensionality reduction method to narrative texts serves to transform a high-dimensionality space (such as the narrative vectors) and represent them in a fewer number of dimensions (typically two). CA output consists of a series of coordinates that represent numeric scores for the narratives and their constituent terms. CA differs from other dimensionality reduction methods (such as Latent Semantic Analysis) in that it treats input data as categorical, and therefore imposes fewer prerequisites on the data. More importantly, it also allows categorical grouping data (such as demographics or occupation), as well as behavior-based outcome measures (such as dichotomous preference or selection), to be represented within the coordinate system without directly affecting the analytical results. Derivative visualization methods, such as biplots of the coordinates, can aid stakeholders in interpreting the analytical results. Output from CA may also be used as input to discriminant analyses to permit more fine-grained distinctions among various groups of interest. As used here, the term discriminant analysis refers to a family of analytical methods that predict membership in two or more predefined groups of interest (such as adopters-vs-non-adopters, geographic or demographic groups, etc.). One or more of these semantic analyses may be implemented by the semantic analysis engine to identify keywords present in both the selected user textual description 32 and canonical textual description 34, and the product artifact report 44a may include a graph 78 that indicates the correspondence of the identified keywords in the canonical textual description 34 and the one or more selected user textual descriptions 36. The product artifact report 44a may also include a consistency score 80 that measures agreement among textual descriptions provided by the plurality of users, and a congruency score 82 that measures agreement between the canonical textual description and the textual descriptions of one or more of the plurality of users.

The product artifact report 44a may further include a display of selected user feedback data 83, in addition to the output of semantic analysis. In the depicted embodiment, the displayed user feedback data 83 includes statistics on product preference, requests for more information, willingness to use, and willingness to recommend the product. These statistics may be based on user input via selectors 60-66 on trial GUI 26. The user feedback data 83 may further include an average elapsed time spent on the selected product artifact by the group of potential users. An eye position data link 83a to view detailed eye position data including dwell times, fixation locations, and transitions, may also be provided.

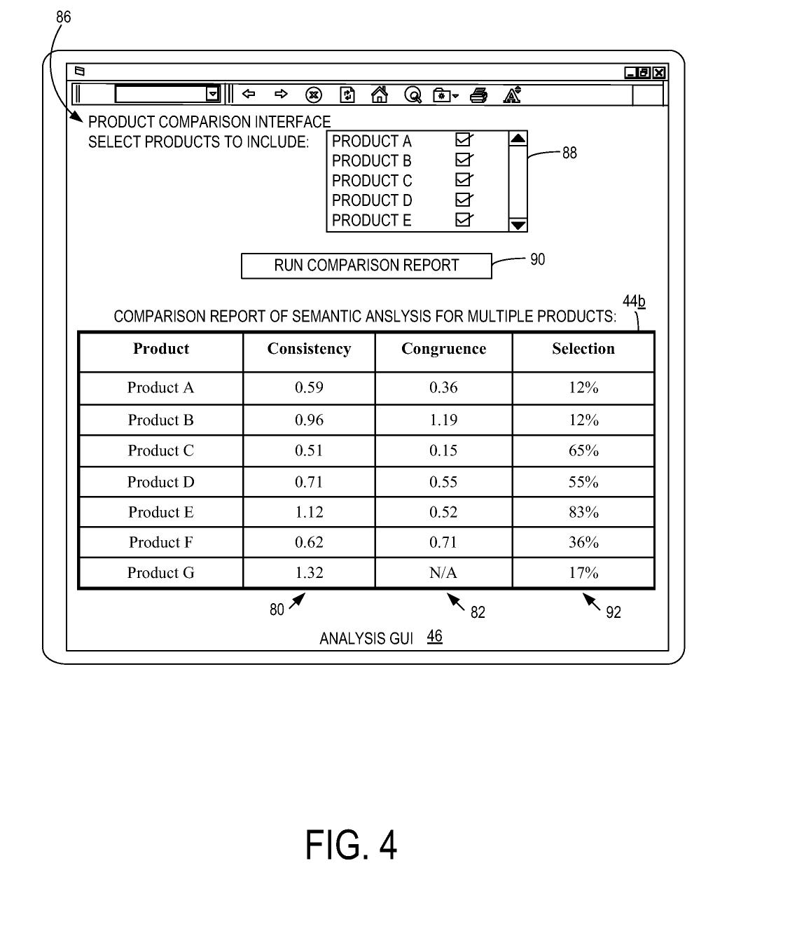

By traversal of a comparison report link 84, a user may navigate to a product comparison interface 86, illustrated in FIG. 4, which is also configured to be generated by the reporting module 42 of the analysis program 36, and displayed on analysis GUI 46. As shown in FIG. 4, the product comparison interface 86 may include a user selector 88 that is configured to enable a user to select multiple products for inclusion in a report containing semantic analysis output for the selected multiple products. While a single user selector 88 is depicted for this task, it will be appreciated that a plurality of such selectors may be provided. Once the user has selected the products to include in the report, the user may select a run selector 90 to run a product comparison report 44b for the selected products and cause the product comparison report 44b to be displayed in the product comparison interface 86. The product comparison report may include consistency scores 80 and congruence scores 82, as well as a selection score 92, for each of the plurality of selected products.

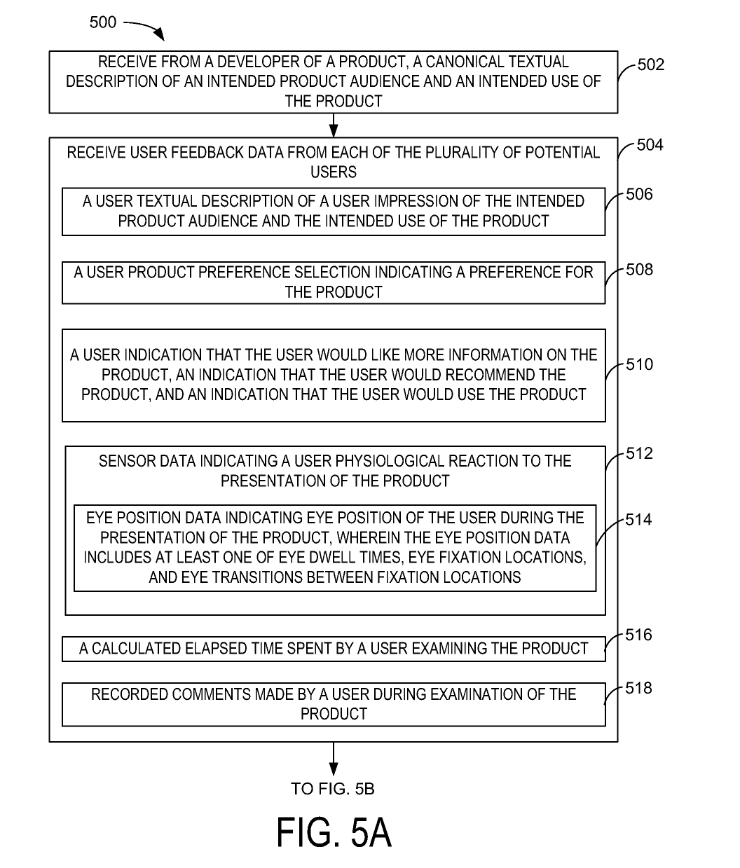

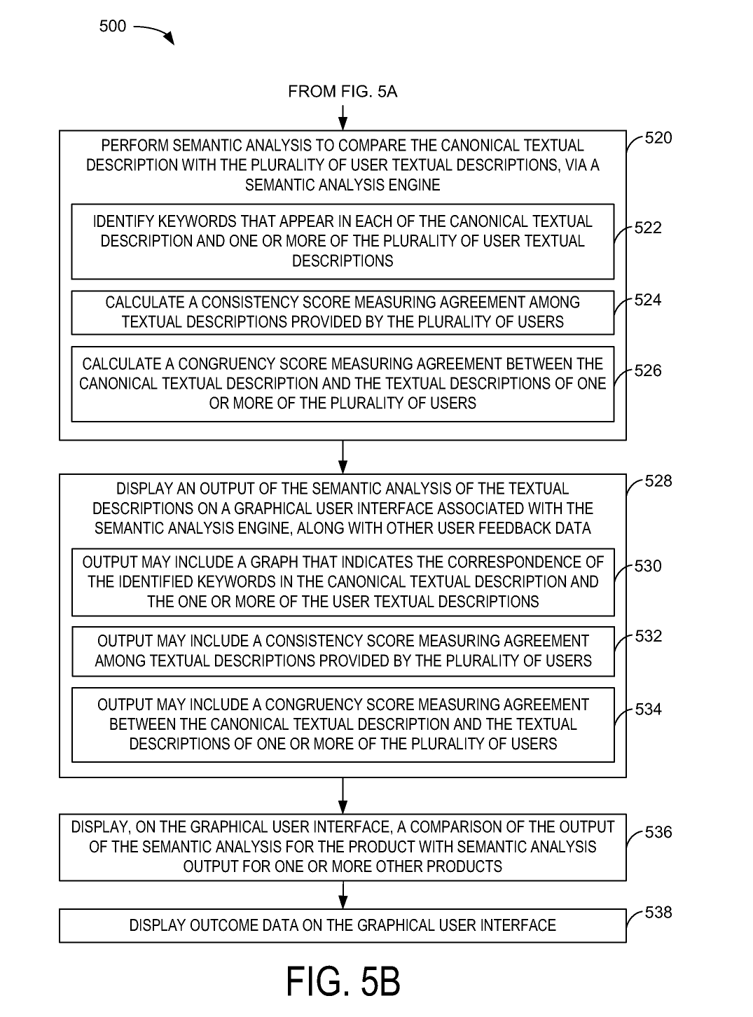

FIGS. 5A and 5B illustrate an embodiment of a method 500 for use in evaluating user impressions of a product. It will be appreciated that method 500 may be implemented via the system 10 described above, however it is also applicable to and may be implemented by other suitable devices and systems. As shown at 502, the method includes receiving from a developer of a product, a canonical textual description of an intended product audience and an intended use of a product. At 504, the method includes receiving user feedback data from each of the plurality of potential users.

As shown at 506, the user feedback data may include, for example, a user textual description 32 of a user impression of the intended product audience and the intended use of the product, which may be input via a text input mechanism 56 as described above. As shown at 508, the user feedback data may also include a user product preference selection indicating a preference for the product, which may be made via a product preference selector 60 as described above. As shown at 510, the user feedback may further include a user selection from the group consisting of an indication that the user would like more information on the product, an indication that the user would recommend the product, and an indication that the user would use the product. These selections may be made via selectors 62-66, described above, for example.

As shown at 512, the user feedback data may further include sensor data that indicates a user physiological reaction to the presentation of the product. As indicated at 514, this sensor data may, for example, be eye position data indicating eye position of the user during the presentation of the product. The eye position data may include eye dwell times, eye fixation locations, and eye transitions between fixation locations, for example.

As shown at 516, the user feedback data may further include a calculated elapsed time spent by a user examining the product. This elapsed time spent may be calculated by timer 28, for example. As shown at 518, the user feedback data may further include recorded comments made by a user during examination of the product. These comments may be recorded, for example, via microphone 21.

Turning now to FIG. 5B, at 520, the method may include performing semantic analysis to compare the canonical textual description with the plurality of user textual descriptions. This may be accomplished, for example, by the semantic analysis engine 40 described above. As indicated at 522, the semantic analysis may include identifying keywords that appear in each of the canonical textual description and one or more of the plurality of user textual descriptions. As indicated at 524, the semantic analysis may further include calculating a consistency score measuring agreement among textual descriptions provided by the plurality of users. As shown at 526, the semantic analysis may further include calculating a congruency score measuring agreement between the canonical textual description and the textual descriptions of one or more of the plurality of users.

As shown at 528, the method may further include displaying an output of the semantic analysis of the textual descriptions on a graphical user interface associated with the semantic analysis engine, along with other user feedback data, as is illustrated in FIG. 3. As indicated at 530, the output may include a graph that indicates the correspondence of the identified keywords in the canonical textual description and the one or more of the user textual descriptions. As indicated at 532, the output may include a consistency score measuring agreement among textual descriptions provided by the plurality of users. And, as indicated at 534, the output may include a congruency score measuring agreement between the canonical textual description and the textual descriptions of one or more of the plurality of users.

As shown at 536, the method may further include displaying, on the graphical user interface, a comparison of the output of the semantic analysis for the product with semantic analysis output for one or more other products, as illustrated in FIG. 4. As shown at 538, the method may further include displaying outcome data on the graphical user interface. The outcome data may be outcome data 55 described above, and may include, for example, statistics relating to users who actually purchase the product or recommend the product to others. These statistics may be correlated to user feedback data and the output of the semantic analysis.

The systems and methods described herein may be used to enable developers to efficiently evaluate user impressions of a product. The results of the semantic analysis can be provided to developers in a feedback loop, to further inform the design and development process. In some applications, these systems and methods may enable developers to iteratively hone their designs to better communicate to users an intended target audience and use.

The above described systems and methods may provide an accurate, repeatable method for representing users' first impressions that works well on time-constrained presentations, and can subsequently be correlated in a systematic and rigorous way to behavior-based outcomes, such as product purchase, or recommendation to a friend or colleague. The systems and methods described herein may be applicable across products, and across multiple iterations of a single product.

It will be appreciated that the computing devices described herein may be any suitable computing device configured to execute the programs and display the graphical user interfaces described herein. For example, the computing devices may be a personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein the term “program” refers to software or firmware components that may be executed by, or utilized by, one or more computing devices described herein, and is meant to encompass individual or groups of executable files, data files, libraries, drivers, scripts, database records, etc.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for use in evaluating user impressions of a product, comprising:
receiving from a developer of a product, a canonical textual description of an intended product audience and an intended use of a product;
receiving from each of a plurality of potential users, a user textual description of a user impression of the intended product audience and the intended use of the product;
performing semantic analysis to compare the canonical textual description with the plurality of user textual descriptions, via a semantic analysis engine; and
displaying an output of the semantic analysis on a graphical user interface associated with the semantic analysis engine.

2. The method of claim 1, wherein the canonical textual description and the user textual description are drafted following an established protocol, which includes asking what does the product do, whom the product is for, and what does the product do for the intended product audience.

3. The method of claim 1, wherein performing the semantic analysis includes calculating a consistency score measuring agreement among textual descriptions provided by the plurality of users.

4. The method of claim 1, wherein performing the semantic analysis includes calculating a congruency score measuring agreement between the canonical textual description and the textual descriptions of one or more of the plurality of users.

5. The method of claim 1, wherein performing semantic analysis includes identifying keywords that appear in each of the canonical textual description and one or more of the plurality of user textual descriptions.

6. The method of claim 5, wherein displaying the output includes displaying a graph that indicates the correspondence of the identified keywords in the canonical textual description and the one or more of the plurality of user textual descriptions.

7. The method of claim 1, further comprising:
receiving a user product preference selection indicating a preference for the product; and
displaying an indication of the user product preference selection on the graphical user interface.

8. The method of claim 7, wherein the user product preference selection is a GUI-forced selection requiring the user to select a preference between two or more products.

9. The method of claim 1, further comprising:
receiving a user selection from the group consisting of an indication that the user would like more information on the product, an indication that the user would recommend the product, and an indication that the user would use the product; and
displaying information relating to the user selection.

10. The method of claim 1, further comprising:
receiving sensor data indicating a user physiological reaction to the presentation of the product;
displaying the sensor data on the graphical user interface.

11. The method of claim 1, further comprising:
receiving eye position data indicating eye position of the user during the presentation of the product; and
displaying the eye position data on the graphical user interface.

12. The method of claim 1, wherein the eye position data includes at least one of eye dwell times, eye fixation locations, and eye transitions between fixation locations.

13. The method of claim 1, further comprising:
calculating an elapsed time spent by a user examining the product;
displaying the elapsed time on the graphical user interface.

14. The method of claim 1, further comprising:
recording comments made by each user during examination of the product; and
presenting the comments via the graphical user interface.

15. The method of claim 1, further comprising:
displaying, on the graphical user interface, a comparison of the output of the semantic analysis for the product with semantic analysis output for one or more other products.

16. A system for evaluating user impressions of a product, comprising:
an analysis computing device configured to receive from a developer of a product, a canonical textual description of an intended product audience and an intended use of a product, and also to receive from each of a plurality of potential users, a user textual description of a user impression of the intended product audience and the intended use of the product;
wherein the analysis computing device is configured to execute an analysis program having a semantic analysis engine, the semantic analysis engine being configured to perform semantic analysis to compare the canonical textual description with the plurality of user textual descriptions, via the semantic analysis engine; and
wherein the analysis program is configured to send an output of the semantic analysis engine for display on a graphical user interface associated with the analysis program.

17. The system of claim 16, wherein the analysis program further includes a preprocessor configured to convert raw input data for the user textual description and the canonical textual description into a processable format for the semantic analysis engine.

18. The system of claim 16, wherein the analysis program further includes a reporting module configured to generate a product artifact report interface having one or more user selectors that are configured to enable a user to select files containing the user textual description and the canonical textual description for the semantic analysis; and
wherein the report module is further configured to generate a product comparison interface having one or more user selectors that are configured to enable a user to select multiple products for inclusion in a report containing semantic analysis output for the selected multiple products.

19. The system of claim 18, further comprising:
a trial computing device configured to display the product to each of the users on a trial graphical user interface, and to receive from each of the users a respective textual description of a user impression of the intended product audience and the intended use of the product; and
wherein the trial computing device further includes one or more of a sensors configured to detect a physiological condition of the user, a camera configured to track eye position of the user, and a microphone configured to record comments of the user while the product is presented to the user; and
wherein an output of the sensors, camera, and/or microphone is configured to be displayed on the graphical user interface of the analysis program along with the output of the semantic analysis.

20. A system for evaluating user impressions of a product, comprising:
an analysis program configured to generate a product artifact report interface having one or more user selectors configured to enable a user to select files containing a user textual description and a canonical textual description of a product for semantic analysis, and a run selector configured to cause the analysis program to perform semantic analysis upon the selected files containing the user textual description and canonical textual description;
wherein upon selection of a run selector by a user, the analysis program is configured to perform semantic analysis, and the product artifact report interface is configured to display an output of the semantic analysis including a consistency score measuring agreement among textual descriptions provided by the plurality of users, a congruency score measuring agreement between the canonical textual description and the textual descriptions of one or more of the plurality of users, and a graph indicating the correspondence of identified keywords in the canonical textual description and the one or more of the user textual descriptions.
